(19) United States
(12) Patent Application Publication
(10) Pub. No.: US 2014/0170264 A1
(43) Pub. Date: Jun. 19, 2014

(54) IMPROVED METHOD FOR MYCELIATING RAW COFFEE BEANS INCLUDING REMOVAL OF CHLOROGENIC ACIDS

(71) Applicant: Mycotechnology, Inc., Louisville, CO (US)

(72) Inventors: Brooks John Kelly, Longmont, CO (US); Quinn Kelly, Longmont, CO (US); Jim Langan, Longmont, CO (US)

(73) Assignee: Mycotechnology, Inc., Louisville, CO (US)

(21) Appl. No.: 14/020,512

(22) Filed: Sep. 6, 2013

Related U.S. Application Data
(60) Provisional application No. 61/697,506, filed on Sep. 6, 2012.
(60) Provisional application No. 61/802,356, filed on Jul. 3, 2013.
(60) Provisional application No. 61/857,671, filed on Jul. 23, 2013.

(51) Int. Cl. A23F 5/02

(52) U.S. Cl. CPC A23F 5/02
USPC 426/45

(57) ABSTRACT

An improved method for myceliating coffee includes providing raw coffee beans, preparing the raw beans for fungal myceliation by removing chlorogenic acids from the green coffee beans inoculating the prepared raw coffee beans with a fungal component to enable fungal myceliation of the green coffee beans. The method includes buffering the aqueous solution with a buffer selected from the group consisting of: sodium chloride, citric acid and ascorbic acid. In one embodiment, the method further includes myceliating the raw coffee beans under optimal conditions for mycelial growth, and preparing the myceliated coffee beans for roasting by washing the myceliated coffee beans to remove undesired metabolites produced by the fungal component. The myceliated coffee beans are roasted. Roasted coffee beans are then ground and brewed into a coffee beverage.

### CROSS-REFERENCE TO RELATED APPLICATIONS

This patent application claims the benefit of U.S. Provisional Patent Application 61/697,506, filed Sep. 6, 2012; U.S. Provisional Patent Application No. 61/802,256, filed on Mar. 15, 2013; U.S. Provisional Patent Application No. 61/857,671, filed Jul. 23, 2013; U.S. Provisional Patent Application, 61/844,498, filed Jul. 10, 2013, the disclosures of which are incorporated herein by reference.

### FIELD OF THE INVENTION

The method pertains to utilizing fungal strains to improve flavor in agricultural substrates, and particularly to improve flavor in coffee.

### BACKGROUND OF THE INVENTION

Coffee has been mixed or infused with fungal components such as dried mushroom powders, or extracts. These mixtures have the benefit of providing additional nutritional value derived from fungal polysaccharides. However, this method of mixing fungal components does little to improve the flavor of the coffee.

U.S. Patent Publication 20100239711 A1 to Pei-Jung Let et al., describes a method of manufacturing coffee by solid state fermentation using fungal mycelium. It is a natural process. Raw coffee is deposited into a dust-free container, the coffee is inoculated with a fungal strain, carried out to perform a sterile operation for implanting fungi into the coffee beans, and a fungal fermentation process is initiated. Antrodia Camphorate, a fungal strain native to Taiwan is utilized. The process takes between 15 to 60 days.

Those intent on commercial scaling of the myceliation process prefer a reduced myceliation (i.e. fungal fermentation) period.

What is desired is a faster and more efficient way of using organic and natural processes to modify the flavor of coffee, and other agricultural substrates.

### SUMMARY OF THE INVENTION

Chlorogenic acids are natural compounds that are the esters of caffeic acid and quinic acid. It is a biosynthetic intermediate. Michael acceptors play an important role in certain various biosynthetic routes of the raw coffee bean, including lignin and tannic acid synthesis.

Chlorogenic acids taste bad and may be toxic to both humans, mammals, and various strains of Fungi. According to toxicological theory, acrylic acid, the derivative functional group of all chlorogenic acids, can result in pulmonary edema if inhaled, and holds an LD50 dose of 340 mg/kg in rats when ingested orally.

Many strains of Fungi can co-exist with chlorogenic acids, but the presence of chlorogenic acids reduces the ability of these fungal strains to optimally metabolize various substrates, including raw coffee beans.

Reducing the coffee bean's concentration of chlorogenic acid, as well as other toxic water-soluble compounds prior to myceliation of the coffee beans ensures rapid myceliation of coffee.

The present invention includes a coffee myceliation process that includes a wash step that improves the rate of fungal myceliation of coffee. In one embodiment an aqueous wash is applied to the raw coffee beans to remove chlorogenic acids from the coffee beans.

A method for myceliating coffee in accordance with the present invention includes providing raw coffee beans, preparing the raw beans for fungal myceliation by removing chlorogenic acids from the green coffee beans, sterilizing or pasteurizing the green coffee beans, and inoculating the prepared raw coffee beans with a fungal component to enable fungal myceliation of the green coffee beans.

The method also includes regulating the environment of the coffee beans to enable fungal myceliation. This includes regulating the temperature, humidity and oxygen content of the air surrounding the coffee beans during fungal myceliation.

The step of preparing the raw beans includes washing the raw beans in a first aqueous solution and a second aqueous solution to remove at least a portion of chlorogenic acid from the raw coffee beans. In one embodiment, both the first and second aqueous solutions are buffered with a buffer selected from the group consisting of: sodium chloride, citric acid and ascorbic acid. The step of sterilizing the raw beans occurs prior to the step of inoculation.

The method further includes myceliating the raw coffee beans, and preparing the myceliated coffee beans for roasting by washing the myceliated coffee beans to remove undesired metabolites produced by the fungal component.

The method preferably includes the step of preparing the myceliated coffee beans includes washing with an aqueous solution. Thereafter the myceliated coffee beans are dried then roasted. Preferably the myceliation process lasts less than 14 days, and more preferably, less than 7 days.

The method according to claim 1 further comprising enabling fungal myceliation of the coffee beans in a facultative anaerobic environment to hasten the myceliation process by utilizing the Pasteur Effect. The step of preparing the raw coffee beans includes hydrating the raw coffee beans to a 40%-70% water content.

### BRIEF DESCRIPTION OF THE DRAWINGS

FIG. 1 is a flow chart of a method for manufacturing coffee in accordance with the present invention.

### DETAILED DESCRIPTION

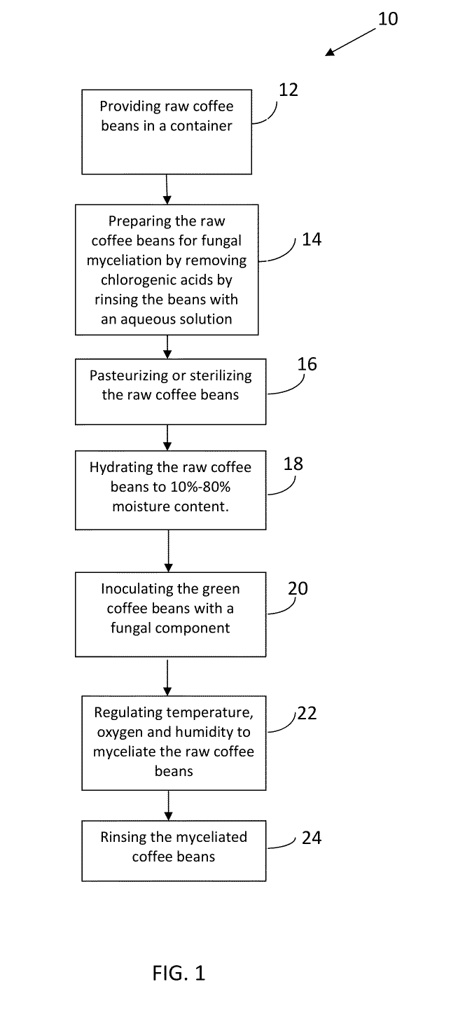

FIG. 1 shows a method 10 of the present invention. The method 10 includes the step 12 of providing raw coffee beans in a container, the step 14 of preparing the raw coffee beans for fungal myceliation by removing chlorogenic acids. In one embodiment the step 14 includes rinsing the beans in an aqueous solution.

The method 10 further includes the step 16 of pasteurizing or sterilizing the raw coffee beans, the step 18 hydrates the raw coffee beans to 10%-80% moisture content, the step 20 inoculates the green coffee beans with a fungal component, the step 22 regulates temperature, oxygen and humidity in the container to myceliate the raw coffee beans. This step 22 optimizes the rate of myceliation. The step 24 rinses the myceliated coffee beans to eliminate surface build-up of mycelial metabolites and other undesired material caused by the myceliation step 22.

A method for manufacturing coffee by clean myceliation comprises the following steps. Step 1: preparing Petri Plate and or Slant Tube agar media of any of the following combinations and concentrations of agar media sterilized at temperature and pressure combinations of 121-122° C. at 15 lb/in²; 115-116° C. at 10 lb/in²; and 108-109° C. at 5 lb/in² for a time period of 5 seconds to 180 minutes: undefined vegetable (of any type but ideally organic) extract, malt extract, malt extract agar, yeast extract, yeast extract agar, potato dextrose agar, raw coffee bean extract, with any liquid media potentially containing any possible mass of any raw coffee bean molecular componentry, with 0 or 15-20 grams of agar per liter of media, pouring the sterile media into a blank Petri Plate or Slant Tube, inoculating these blanks with wild and healthy Fungi of proper quality that are disinfected, or from mycelial samples of already cultivated Petri Plates or Slant Tubes, or from samples of other myceliated agriculture of any agricultural substrate, much less raw coffee beans, with the option of placing sterile raw coffee beans into any blank Petri Plate/Slant Tube once the media has cooled before, during, or anytime after inoculation, and cultivating these Petri Plates/Slant Tubes for 4-90 days at any temperature but ideally at 87-89 degrees Fahrenheit, where one repeats this cycle up to 100 times to train the Fungi according to the media preparation to better recognize raw coffee beans or any particular bimolecular component of raw coffee beans as an energy source. Step 2: preparing liquid media of any of the following combinations and concentrations of liquids/solids that are to be sterilized at one of the temperature and pressure combinations of 121-122° C. at 15 lb/in²; 115-116° C. at 10 lb/in²; and 108-109° C. at 5 lb/in² for a time period of 5 seconds to 180 minutes: undefined vegetable (of any type but ideally organic) extract, malt extract, malt extract agar, yeast extract, yeast extract agar, potato extract, potato dextrose, potato dextrose agar, raw coffee bean extract, and any mass of any raw coffee bean molecular componentry. This media can be in any size ball jar for floating liquid tissue culture, in any size Erlenmeyer flask for non-continuous liquid tissue culture, or pneumatically injected or poured into a fermentor/bioreactor that if jacketed is held at 87-89 degrees Fahrenheit and experiences and agitation rate of 50-240 RPM (same agitation rate as on shaker table), ideally an agitation rate of 85-95 RPM (also same for shaker table method), and is inoculated by any cultivated Petri Plate or Slant Tube sample as described above, or any other liquid tissue sample of the floating or non-continuous submerged form, and is incubated for 4-90 days at any temperature but ideally at a temperature of 87-89 degrees Fahrenheit, whereas if pneumatically injected through a series of one-way valves or poured into a fermentor/bioreactor held at the conditions previously mentioned, will fill the fermentor/bioreactor to capacity and ideally rejuvenate mycelial concentration of fermentor/bioreactor media as soon as up to 6 days, if this cultivation method is the desired method, and ideally it is, wherein any of these cultivation techniques are cycled through 1-100 times in order to train the Fungi, as discussed previously. Step 3: placing raw coffee beans in to a dust-free, clean container for at least one but to the discretion of the manufacturer an indefinite number of aqueous washes, whether at room temperature, under pressure (1.01-1,000 ATM) or in a vacuum, so that every bean is thoroughly soaked and the aqueous mixture is eluted off, placing the washed raw coffee beans into a clean, dust-free autoclavable bag with 0.01-10 micron breather patch (or keeping the beans in the original washed containers if those containers are capable of pressure treatment, such as a ball jar, though bags are preferable for various reasons) and sterilizing the washed raw coffee beans in a pressure vessel at one of a temperature and pressure combination of either 121-122° C. at 15 lb/in²; 115-116° C. at 10 lb/in²; and 108-109° C. at 5 lb/in² for a time period of 5 seconds to 180 minutes. Step 4: carrying out inoculation, using any of the cultivation methods and references described above in regard to Petri Plate/Slant Tube, all forms of liquid tissue culture and the use of other myceliated agricultural samples as substrate, ideally continuous submerged liquid tissue culture with mycelial spheres as small as 5 microns in diameter, ideally done pneumatically through a system of one-way valves, wherein the mycelial sample/aliquot is introduced to the washed sterile raw coffee beans contained in the dust-free clean autoclavable bag with 0.01-10 micron breather patch or other container type in sterile operation and the fungus being a strain belonging to Eumycota, Basidiomycotina or Ascomycotina, most specifically and importantly the strains listed here in the abstract and claims. Step 5: performing a myceliation of washed and sterile raw coffee beans for 4-90 days in a clean-room or clean environment at any temperature, though ideally at 87-89 degrees Fahrenheit. Step 6: subjecting the fully myceliated raw coffee beans to an optional aqueous wash to remove undesired metabolite build-up, and optionally drying the beans for any time up to 12 weeks, ideally so that they return to their original moisture content, to prepare the beans for roasting and subsequent consumption. All manipulation of the Fungi and all work done with sterile material should be done in a clean room area of Class 10,000 or greater, where the air system quality is capable of removing 99.997% of all particles of 0.3 microns in diameter, and in another embodiment where the air system is capable of removing 99.997% of all particles 0.12 microns in diameter.

In another embodiment, one could set up a room to fruit mushroom bodies in and collect spores from their build up on filters in the room's air system (this could be done for any of the Fungi listed herein). Upon collecting the spores in a clean, dust-free container such as a ball jar, the spores are weighed and then stored dry, at room temperature. To utilize for inoculation, known quantities of spores are mixed with buffer such that for every 1-20 g spores approximately 10-1,000 mL of buffered aqueous solution is added to create a spore-slurry. This slurry is maintained at room temperature, in aliquots and used immediately after preparation to inoculate multiple samples of sterilized agricultural substrate.

In another embodiment all liquid cultivation media are sterilized by way of microfiltration.

The use of an autoclavable bag with appropriate breather patch, as described above, enables 1 g-10,000 lb to be sterilized in one pressure vessel run, according to the size of the bag and pressure vessel, and multiple bags to be used given the same considerations. The bag can be elongated or flattened to hasten the heating process. For example, in one embodiment the bags are tubes having a length greater than three times the diameter of each bag. In this way, heat is more effectively transferred from the bag surface to the coffee beans contained therein. Further, having a tubular shaped bag enables stacks of bags to be positioned in an autoclave to effectuate sterilization or pasteurization.

In another embodiment, the bags are flattened, having a thickness of 1/10th or less than the sum of the peripheral edges of each bag. The bags can be round in shape, having a circumference that defines the peripheral edges of each bag. Alternatively, the bags can be rectangular so that the sum of the sides defines the peripheral edges of each bag. The bags can be conjoined so that a series of rectangular bags can be easily handled in a production environment.

In another embodiment, the bags are autoclavable plastic bags with breather patches capable of inhibiting contamination when in a non-sterile environment, wherein the bags have a surface area of at least 55.25 in², where the dimensions of the base of the bag when full are 6.5 in×8.5 in, where the breather patch is positioned on the bottom half of the bag allowing the bag to be sealed when filled to any extent as the height of the bag is approximately 19 in and will be sealed down to the boundary line of where the coffee beans lie (an appropriate coffee bean weight to fill the bags with is 10.4 lbs., though this is not a steadfast rule inhibiting the art, as the bags can be filled to any extent that they are still sealable and capable of fitting into any desired pressure vessel lading schematic).

In yet another embodiment, the bags are flattened to hold a layer of beans being less than three beans thick. Accordingly, heat quickly penetrates the flattened bags to the beans to effectuate sterilization or pasteurization. In this embodiment, due to the pressurization, the bag will conform to the shape of the coffee, and this will yield a pebbled surface on the outer surface of each bag when pressure is applied. The pebbled bag surface forms interstitial spaces that allow heat to penetrate between bags that are stacked to accelerate the sterilization process. The pebbled surface of the bags also induces turbulent fluid flow along the bag surface to improve heat transfer to the coffee beans.

In yet another embodiment, the coffee beans are vacuum packed in bags to eliminate air that could draw volatile flavor or aromatic components from bags then subjected to heat treatment.

In yet another embodiment, the bags are replaced by sheets of autoclavable material, such as BPA-free plastic. One base sheet is continuously dispensed along the top of a conveyor as coffee beans are then laid on the dispensed base sheet. A second top sheet is overlaid upon the coffee beans and sealed to the base sheet. A vacuum is applied between the top and bottom sheet to evacuate air, then the sheets are sealed at predetermined distances to form sections. Each section holds a pre-determined volume of coffee beans

The sections are conveyed through an autoclave, to effectuate the sterilization process. Heat may be applied in a pressurized or non-pressurized environment in the form of steam, hot water under pressure, hot air in turbulent or laminar flow over the sheets, or other heated fluid. In a variation of this embodiment, the sections containing the coffee beans are rolled and placed in an autoclave for sterilization. One roll can contain many sections.

Since the coffee beans cause a pebbled surface on the exterior of the sheets, interstitial space exists on the outside surface of the sheets to hasten the sterilization process by allowing heated fluid to readily penetrate between sheets. The pebbled sheet surface also induces turbulent fluid flow that further improves heat transfer to the coffee beans. To ensure heat transfer, a spacer of aluminum is placed between layers. The pebbled surface inhibits relative movement between beans assuring that beans don't crack, break or rub. All equipment is reusable.

Once substrate has been sterilized, the subsequent facultative anaerobic metabolic activity of the Fungi as described by the Pasteur Effect can be induced upon inoculation, given the bag has a breather patch and the jar is nearly but not completely sealed. This is performed in each sheet section, or in each container, until completion of myceliation.

In an alternate embodiment, the coffee beans are removed from the sheets and deposited in large stainless steel vats in a sterile environment. The vats regulate oxygen levels and temperature, and enable the facultative anaerobe activity and mycelial growth on the coffee beans. A major benefit of facultative anaerobic growth of the Fungi is that cellulose in beans is consumed much more rapidly compared with growth in strictly aerobic or anaerobic environments.

In alternate embodiments of the substrate, agar, and liquid media containers, the containers are made of glass, stainless steel, temperature-resistant high density polyethylene (HDPE), and polypropylene (PP) or other types of containers that are resistant to the high temperatures of sterilization, have breather patches, and may of may not have built in one way valves for pneumatic manipulation of media or inoculant wherein the fermentors or bioreactors also have these valves, allowing for sterile aeration of this equipment in one embodiment.

Coffee beans may be of any type including Arabica coffee, Robusta coffee, and Liberica coffee, and any derivative species of coffee including any genetically-modified (GMO) strains or cultivars and also any heirloom variety (non-GMO) strains or cultivars of coffee.

In another embodiment, the inoculation is done on pasteurized raw coffee beans, wherein coffee beans are subjected to dry heat treatment instead of being sterilized in a pressure vessel.

In one embodiment, the culture may be pneumatically injected into the container such as the autoclavable bags, or sections. In this embodiment, moisture may also be injected into bags to optimize mycelial growth. Injection of the inoculants, or moisture, is performed after the sterilization or pasteurization, and after the coffee beans and containers have cooled to less than 100 degrees Fahrenheit. In another embodiment the coffee beans are inoculated by pouring the culture into the container holding the sterilized coffee beans either manually or through a valve built into the fermentor or bioreactor, from any variety of liquid tissue culture. The pneumatic method is most preferred if the equipment is available.

In various embodiments Fungi are selected from phylum Basidiomycotina of Eumycota, including any Fungi belonging to Polyporaceae and Hericiaceae, wherein Fungi selected from Basidiomycotina of Eumycota include Polyporaceae such as Antrodia camphorata; Hericiaceae, such as Hericium erinaceus; Pleurotaceae, such as Pleurotus ostreatus and Lentinula edodes; Tricholomataceae, such as Airmillariella mellea, Tricholoma matsutake, and Flammulina velutipes; Pluteaceae, such as Vovariella volvacea; Agaricaceae, such as Agaricus campestris, Grifola frondosa, and Agaricus blazei; Bolbitiaceae, such as Agrocybe cylindracea; Boletaceae, such as Boletus ornatipes; Ganodermataceae, such as Ganoderma lucidum and Ganoderma applanatum; Hymenochaetaceae, such as Phellinus linteus; Homobasidiomycota such as Pholiota nameko, and Auriculariaceae, such as Auricularia auricula and Tremella fuciformis, and other Fungi such as Laetiporus sulfureus, Fomes fomentarius, Bridgeoporus nobilissimus, Inonotus obliquus, and all other species of Pleurotus,

The Fungi used in this invention for clean myceliation of raw coffee beans may also include Ascomycotina of Eumycota, including Clavicipitaceae, wherein the Fungi selected from Ascomycotina of Eumycota include Clavicipitaceae such as Cordyceps sinensis and Cordyceps militarus; and Xylariaceae, such as Xylaria nigripes.

Mycelium produced from pure strains of Fungi cultivated in any solid-state or any liquid-state cultivation medium are thus provided, and are then transferred to a fermentation cultivation medium to efficiently multiply and propagate the fungus mycelium on washed and sterilized raw coffee beans.

Multiplication of the fungal mycelia by fermentation is carried out by efficiently controlling environmental light, such as by a control model of 40% lighting and 60% dark, and also by controlling sterile airflow and temperature at 87-89 degrees Fahrenheit.

The relative humidity of the myceliation controlled between 20% and 80% and an incubation period is set to between 4 and 90 days. The incubation temperature is controlled between 12 and 35° C. Myceliation incubation temperatures in prior work has usually been between 12 and 35° C. However, it has been observed by the inventors in this work that temperature of fermentation are not limited to such a range, as the optimum temperature of the Fungi utilized in this method has been shown to be around 24° C. to 32° C.

For example, 1000 g of myceliated roasted coffee beans may be fully extracted, with agitation, using 10 to 1000 ml of 121-122° C. pressurized water as a buffer, containing 0.01% to 10% Citric Acid and 0.01 to 10% Ascorbic Acid. The resulting aqueous extract may be further purified and concentrated by anyone with familiarity in the art. Myceliated coffee extracts may be given an extended shelf life by formulated modification using either 18% to 24% alcohol or 45% to 60% glycerol, or addition of 2.5 volumes of honey or similar sugar such as maple syrup or evaporated cane sugar. Stock solutions made from roasted myceliated coffee beans are utilized commercially in the production of libations such as energy drinks. The formulae for solid-state and liquid-state fermentation as described herein have been optimized for suitable propagation of Fungi whereby the medium of choice utilized comprises raw coffee beans as the sole carbon source, the sole nitrogen source, and the source of all vitamins, cofactors and inorganic substances. Additionally, trace elements and organic substances such as water, nucleic acids, and minerals may be added with inoculant. The carbon source and the nitrogen source are obtained from any of the previously mentioned substances. The pH of the raw coffee beans is preferably between pH 4 to 7. The temperature is optimally controlled at 22±10° C. The water content for this clean fermentation is optimally set between 40%-70%, while the relative humidity is preferably between 60%-80%.

The incubation period for liquid-state or solid-state cultivation of fungus is between 4 and 90 days, depending on conditions and desired maturation levels, where completion of myceliation normally occurs preferably between 4 and 15 days after inoculation. Prior to roasting, cultures of coffee are optionally rinsed with water to remove any buildup of any secondary metabolites generated by the fungal metabolization of the coffee beans, then the coffee beans are dried.

Compared to the known techniques, the present invention adopts a turn-key method for propagation of fungus in a sterile operation for myceliation of raw coffee beans, during a period of 4 to 20 days, as a pure culture, without being contaminated by any other microorganisms, for flavor enhancement. The present invention provides a new method for manufacturing coffee that enhances flavor and taste.

While certain novel features of this invention have been shown and described and have been pointed out in the aforementioned annexed claims, this disclosure is not intended to be limited to the details above, since it will be understood to anyone versed in the art that various omissions, modifications, substitutions and changes in the forms and detail of the device illustrated and in its operation can be made without departing in any way from scope or spirit of the present invention.

We claim:

1. A method for myceliating coffee, comprising:
providing raw coffee beans;
preparing the raw coffee beans for fungal myceliation by removing chlorogenic acids from the raw coffee beans; and
inoculating the prepared raw coffee beans with a fungal component to enable fungal myceliation of the raw coffee beans.

2. The method according to claim 1, wherein the step of preparing the raw beans includes washing the raw beans in a first aqueous solution.

3. The method according to claim 2, wherein the aqueous solution is buffered with a buffer selected from the group consisting of: sodium chloride, citric acid and ascorbic acid.

4. The method according to claim 1, wherein the step of preparing the raw beans includes washing the raw beans in a first aqueous solution, and re-washing the raw beans in a second aqueous solution.

5. The method according to claim 3 further comprising sterilizing the raw beans prior to the step of inoculation.

6. The method according to claim 1 further comprising: myceliating the raw coffee beans, and preparing the myceliated coffee beans for roasting by washing the myceliated coffee beans to remove undesired metabolites produced by the fungal component.

7. The method according to claim 6, wherein the step of preparing the myceliated coffee beans includes washing with an aqueous solution.

8. The method according to claim 7 further comprising drying and roasting the myceliated coffee beans.

9. The method according to claim 1, further comprising enabling mycelial growth by regulating growth conditions for a period of less than 14 days.

10. The method according to claim 1, further comprising enabling mycelial growth by regulating growth conditions for a period of less than 7 days.

11. The method according to claim 1 further comprising enabling fungal myceliation of the coffee beans in a facultative anaerobic environment to hasten the myceliation process by utilizing the Pasteur Effect.

12. The method according to claim 11, wherein the step of preparing the raw coffee beans includes hydrating the raw coffee beans to a 40%-70% water content.

13. A method for myceliating coffee, comprising:
providing raw coffee beans in a container;
preparing the raw beans for fungal myceliation by removing chlorogenic acids from the raw coffee beans by rinsing the raw coffee beans with an aqueous solution;
sterilizing the raw coffee beans;
inoculating the sterilized raw coffee beans with a fungal component to enable fungal myceliation of the green coffee beans;
regulating temperature, humidity and oxygen availability in the container to optimize mycelial growth to achieve myceliated coffee beans; and
rinsing the myceliated coffee beans.

14. The method according to claim 14 further comprising drying and roasting the rinsed myceliated coffee beans.
